(19) United States
(12) Patent Application Publication
(10) Pub. No.: US 2022/0267000 A1
(43) Pub. Date: Aug. 25, 2022

(54) ARTIFICIAL INTELLIGENT SHEPHERD BEE

(71) Applicant: Dongxu Zhang, Guangzhou (CN)

(72) Inventor: Dongxu Zhang, Guangzhou (CN)

(21) Appl. No.: 17/372,404

(22) Filed: Jul. 9, 2021

(30) Foreign Application Priority Data
Feb. 22, 2021 (CN) 202110198284.X

(51) Int. Cl. B64C 39/02; B64C 27/00; B64D 27/24; B60L 8/00; B64D 47/08; B60L 50/60; A01K 15/02; B64C 25/32; H04N 7/18

(52) U.S. Cl. CPC B64C 39/024; B64C 27/006; B64D 27/24; B60L 8/003; B60L 8/006; B64D 47/08; B60L 50/60; A01K 15/02; B64C 25/32; H04N 7/185; B60L 2200/10; B64C 2201/027; B64C 2201/042; B64C 2201/108; B64C 2201/127

(57) ABSTRACT

The invention discloses a shepherd unmanned aerial vehicle device comprising an unmanned aerial vehicle rack, a rotor wing device, a power supply device, a shepherd device and an unmanned aerial vehicle control host arranged in the unmanned aerial vehicle rack; said rotor wing device comprises first rotor wing mechanisms and second rotor wing mechanisms which are arranged on the unmanned aerial vehicle rack; the power supply device comprises lithium batteries, wind power generation wheel wing mechanisms and a solar panel; said lithium battery is arranged at the upper end of the unmanned aerial vehicle rack; the shepherd device comprises a power grid mechanism, an infrared scanning mechanism and a camera; by the way of detecting flocks of sheep via the camera and the infrared scanning mechanism on the unmanned aerial vehicle rack, the power grid mechanism reaches the effect of controlling the flocks of sheep within working range.

### BACKGROUND OF THE INVENTION

### 1. Field of the Invention

The invention relates to the technical field of unmanned aerial vehicle, specifically relating to an artificial intelligent shepherd bee.

### 2. Description of the Related Art

Traditional manual shepherd is the grazing mode that most herdsmen chose, and herdsmen have to guarantee the completeness of flocks of sheep and the health of sheep, lets the flocks of sheep migrate smoothly between meadow and sheepfold, and make them free from the invasion and attack of wild animals; despite there is the help of herdsdogs, for pursuing and protecting the flocks of sheep, the herdsman often will walk on the desolate and uninhabited meadow for tens of miles in a day.

This work is time consuming and laborious for both humans and shepherds. While unmanned autogyro, given its flight flexibility, good security, unique performance such as collaborative operation, making it play an important role in aspects such as target search and target tracking control, which is applied to grazing in pasture and can effectively save manpower and material resources. unmanned aerial vehicle is big in controllable radius, has strong adaptability in supervising flocks of sheep, and can fly back automatically after consuming the electricity, the operation of which is convenient.

Therefore, the above mentioned technical problems are an urgent problem to be solved by those skilled in the art.

### SUMMARY OF THE INVENTION

The technical problem to be solved by the invention is to overcome the defects in prior art and provides an artificial intelligent shepherd bee.

In order to solve the technical problem, the technical solution provided by the invention is that a shepherd unmanned aerial vehicle device comprises: the system comprises an unmanned aerial vehicle rack, a rotor wing device, a power supply device, a shepherd device and an unmanned aerial vehicle control host arranged in the unmanned aerial vehicle rack;

said rotor wing device comprises first rotor wing mechanisms and second rotor wing mechanisms which are arranged on the unmanned aerial vehicle rack; said second rotor wing mechanism is far away from the unmanned aerial vehicle rack compared with the first rotor wing mechanism; said first rotor wing mechanism and the second rotor wing mechanism respectively comprise a connecting arm, a protective cover and a rotor wing body;

said power supply device comprises lithium batteries, wind power generation wheel wing mechanisms and a solar panel; said lithium battery is arranged at the upper end of the unmanned aerial vehicle rack; said wind power generation wheel wing mechanism is arranged in array at the top end of the lithium battery and consists of a fixing plate arranged at the top end of the lithium battery and wheel wings arranged on the fixing plate; a liquid crystal control screen is arranged at the upper part of the fixing plate close to the rear end of the unmanned aerial vehicle rack; said solar panel is arranged at the top end of the fixing plate;

said shepherd device comprises a power grid mechanism, an infrared scanning mechanism and a camera; said power grid mechanism comprises a power grid body and an electric shock generating source; said power grid body is arranged on the outer side of said first rotor wing mechanism, and a connecting plate connected with the first rotor wing is arranged on the inner side wall; one end of said electric shock generating source is fixedly connected with the rear end of the unmanned aerial vehicle rack while the other end thereof is fixedly connected with the power grid body; said infrared scanning mechanism comprises a fixed frame arranged on the lower side of the first rotor wing mechanism and infrared devices symmetrically arranged on two sides of the bottom end of the fixed frame; said camera sets up in unmanned aerial vehicle rack front end.

As an improvement, unmanned aerial vehicle rack bottom is equipped with supporting legs which are in array distribution, the universal wheels are provided on the supporting leg.

As an improvement, said first rotor wing mechanisms are four and locate at both sides of unmanned aerial vehicle rack in a mode of bilaterally symmetric to each other.

As an improvement, said second rotor wing mechanisms are four and locate at both sides of unmanned aerial vehicle rack in a mode of bilaterally symmetric to each other.

As an improvement, the number of the wind power generation wheel wing mechanisms is not less than 3.

As an improvement, the number of the infrared scanning modules in the infrared device is not less than 8.

A shepherd unmanned aerial vehicle system comprises a shepherd unmanned aerial vehicle device, a data analysis module, a logic control module, a monitoring terminal and a control terminal;

said shepherd unmanned aerial vehicle device is used for monitoring and finding targets or target groups within the working range and restraining the targets or the target groups within the working range;

said data analysis module analyzes the monitoring information of the shepherd unmanned aerial vehicle device and sends analysis results to the logic control module; said logic control module judges to control the shepherd unmanned aerial vehicle device according to preset logic control and analysis results;

said monitoring terminal is used for remotely receiving and displaying the monitoring video of the shepherd unmanned aerial vehicle device;

said control terminal is used for manually and remotely controlling the shepherd unmanned aerial vehicle device.

As an improvement, the system also comprises a wireless module which is used for receiving or generating data information among the shepherd unmanned aerial vehicle device, the monitoring terminal and the control terminal.

As an improvement, said monitoring information is target information acquired by the camera and the infrared scanning mechanism.

Compared with the prior art, the invention has the advantages that: by the way of detecting flocks of sheep via the camera and the infrared scanning mechanism on the unmanned aerial vehicle rack, the power grid mechanism reaches the effect of controlling the flocks of sheep within working range, which can effectively reduce the time and energy that herdsman consumed in the process of grazing, accomplishes the real-time guardianship management to the flocks of sheep and improve the modernization degree of animal husbandry.

### BRIEF DESCRIPTION OF THE DRAWINGS

FIG. 1 is the structural diagram 1 of the shepherd unmanned aerial vehicle device.

FIG. 2 is the structural diagram 2 of the shepherd unmanned aerial vehicle device.

FIG. 3 is the structural diagram 3 of the shepherd unmanned aerial vehicle device.

FIG. 4 is the structural diagram 4 of the shepherd unmanned aerial vehicle device.

FIG. 5 is the system flowchart of the shepherd unmanned aerial vehicle device system.

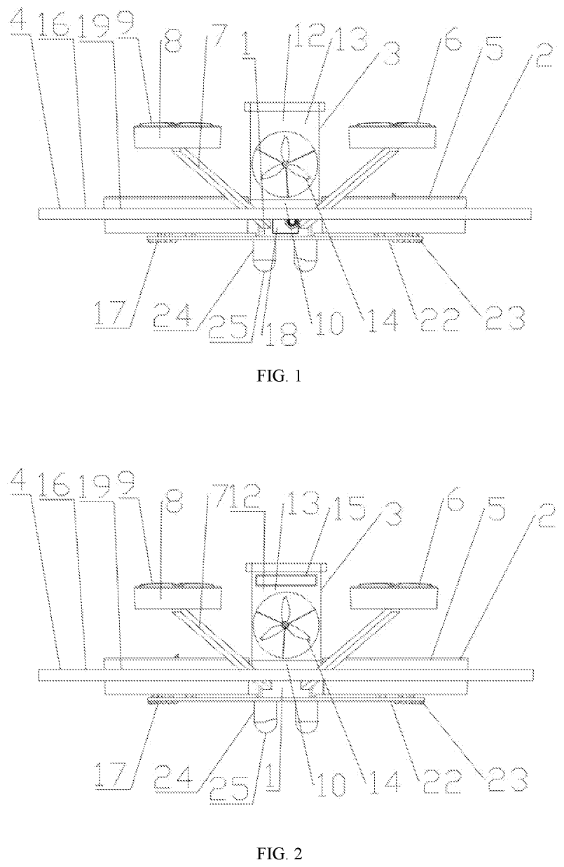

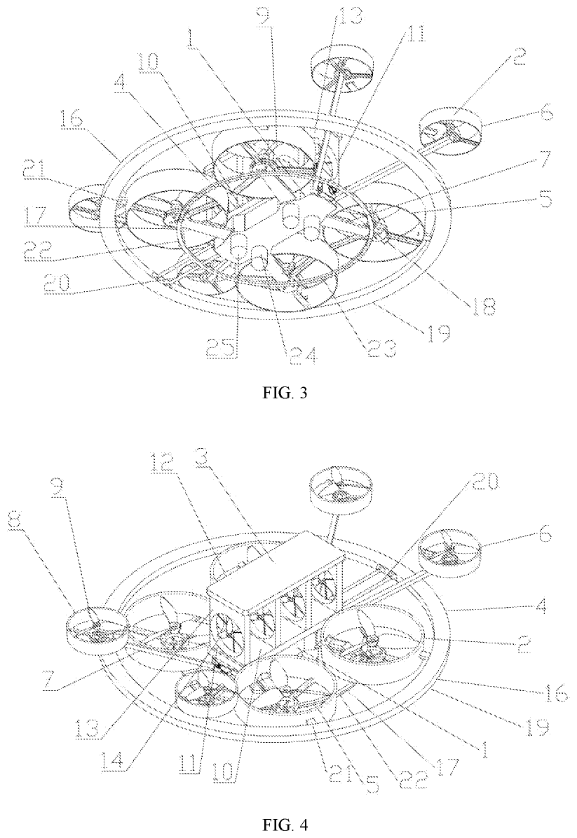

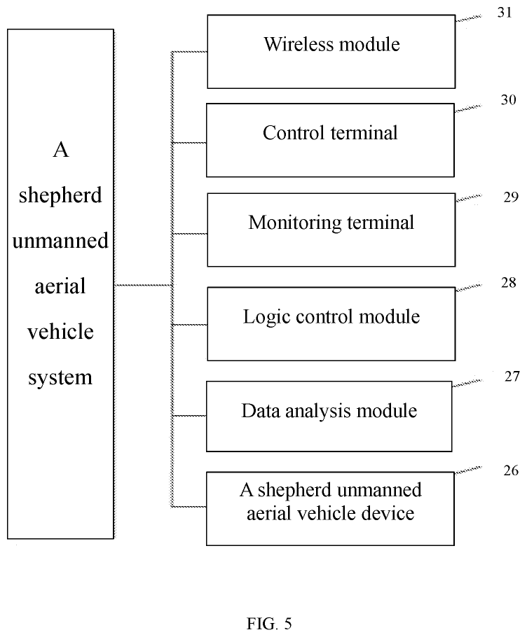

As is shown in drawings, 1. unmanned aerial vehicle rack, 2.rotor wing device, 3.power supply device, 4.shepherd device, 5.first rotor wing mechanism, 6.second rotor wing mechanism, 7.connecting arm, 8.protective cover, 9.rotor wing body, 10.1ithium batteries, 11.wind power generation wheel wing mechanism, 12.solar panel, 13.fixing plate, 14.wheel wings, 15.liquid crystal control screen, 16. power grid mechanism, 17.infrared scanning mechanism, 18.camera, 19.power grid body, 20. electric shock generating source, 21. connecting plate, 22.fixed frame, 23.infrared device, 24.supporting leg, 25.universal wheel, 26.unmanned aerial vehicle device, 27.data analysis module, 28.1ogic control module, 29.monitoring terminal, 30.control terminal, 31.wireless module.

### DETAILED DESCRIPTION OF THE PREFERRED EMBODIMENTS

Reference will now be made in detail to the embodiments of the invention, embodiments of which are illustrated in the drawings, wherein like reference numerals refer to the same or similar elements or elements having the same or similar functions throughout. In the description of the invention, it is to be understood that the terms “upper”, “lower”, “front”, “rear”, “left”, “right”, “inner”, “outer”, “vertical”, “circumferential”, and the like indicate orientations or positional relationships based on orientations or positional relationships shown in the drawings, merely for convenience of description and simplicity of description, and do not indicate or imply that the device or element being referred to must have a particular orientation, be constructed and operated in a particular orientation, and thus, are not to be construed as limiting the invention.

In the description of the present invention, “the first feature” and “the second feature” may include one or more of the features. Furthermore, the terms “first”, “second” and “first” are used for descriptive purposes only and are not to be construed as indicating or implying relative importance or to implicitly indicate the number of technical features indicated. Thus, a feature defined as “first” or “second” may explicitly or implicitly include one or more of that feature.

The artificial intelligent shepherd bee is further described in detail hereinafter with reference to the drawings.

With reference to drawings, an unmanned aerial vehicle device 26 comprises an unmanned aerial vehicle rack 1, a rotor wing device 2, a power supply device 3, a shepherd device 4 and an unmanned aerial vehicle control host arranged in the unmanned aerial vehicle rack 1;

said rotor wing device 2 comprises first rotor wing mechanisms 5 and second rotor wing mechanisms 6 which are arranged on the unmanned aerial vehicle rack 1; said second rotor wing mechanism 6 is far away from the unmanned aerial vehicle rack 1 compared with the first rotor wing mechanism 5; said first rotor wing mechanism 5 and the second rotor wing mechanism 6 respectively comprise a connecting arm 7, a protective cover 8 and a rotor wing body 9;

said power supply device 3 comprises lithium batteries 10, wind power generation wheel wing mechanisms 11 and a solar panel 12; said lithium battery 10 is arranged at the upper end of the unmanned aerial vehicle rack 1; said wind power generation wheel wing mechanism 11 is arranged in array at the top end of the lithium battery 10 and consists of a fixing plate 13 arranged at the top end of the lithium battery 10 and wheel wings 14 arranged on the fixing plate 13; a liquid crystal control screen 15 is arranged at the upper part of the fixing plate 13 close to the rear end of the unmanned aerial vehicle rack 1; said solar panel 12 is arranged at the top end of the fixing plate 13;

said shepherd device 4 comprises a power grid mechanism 16, an infrared scanning mechanism 17 and a camera 18; said power grid mechanism 16 comprises a power grid body 19 and an electric shock generating source 20; said power grid body 19 is arranged on the outer side of said first rotor wing mechanism 5, and a connecting plate 21 connected with the first rotor wing is arranged on the inner side wall; one end of said electric shock generating source is fixedly connected with the rear end of the unmanned aerial vehicle rack 1 while the other end thereof is fixedly connected with the power grid body 19; said infrared scanning mechanism 17 comprises a fixed frame 22 arranged on the lower side of the first rotor wing mechanism 5 and infrared devices 23 symmetrically arranged on two sides of the bottom end of the fixed frame 22; said camera 18 sets up in unmanned aerial vehicle rack 1 front end.

Said unmanned aerial vehicle rack 1 bottom is equipped with supporting legs 24 which are in array distribution, the universal wheels 25 are provided on the supporting leg 24.

Said first rotor wing mechanisms 5 are four and locate at both sides of unmanned aerial vehicle rack 1 in a mode of bilaterally symmetric to each other.

Said second rotor wing mechanisms 6 are four and locate at both sides of unmanned aerial vehicle rack 1 in a mode of bilaterally symmetric to each other.

the number of said wind power generation wheel wing mechanisms 11 is not less than 3.

the number of said infrared scanning modules in the infrared device 23 is not less than 8.

Said shepherd unmanned aerial vehicle system comprises a shepherd unmanned aerial vehicle device 26, a data analysis module 27, a logic control module 28, a monitoring terminal 29 and a control terminal 30;

said shepherd unmanned aerial vehicle device 26 is used for monitoring and finding targets or target groups within the working range and restraining the targets or the target groups within the working range;

said data analysis module 27 analyzes the monitoring information of the shepherd unmanned aerial vehicle device 26 and sends analysis results to the logic control module 28; said logic control module 28 judges to control the shepherd unmanned aerial vehicle device 26 according to preset logic control and analysis results;

said monitoring terminal 29 is used for remotely receiving and displaying the monitoring video of the shepherd unmanned aerial vehicle device 26;

said control terminal 30 is used for manually and remotely controlling the shepherd unmanned aerial vehicle device 26.

the system also comprises a wireless module 31 which is used for receiving or generating data information among the shepherd unmanned aerial vehicle device 26, the monitoring terminal 29 and the control terminal 30.

said monitoring information is target information acquired by the camera 18 and the infrared scanning mechanism 17.

In the specific implementation of the invention, the lithium battery 10 in the power supply device 3 supplies power to the whole shepherd unmanned aerial vehicle device 26, the wind power generation wheel wing mechanism 11 and the solar panel 12 charge the lithium battery 10, the liquid crystal control screen 15 controls and operates the shepherd unmanned aerial vehicle device 26, the camera 18 and the infrared scanning mechanism 17 realize the discovery and monitoring of samples or sheepfold, the monitoring message is sent to the data analysis module 27 through the wireless module 31, the analysis result is used for judging whether the target is separated from the working range, when the target separated from the working range is discovered, the logic control module 28 controls the shepherd unmanned aerial vehicle device 26 to electrify the power grid body 19 by clicking the generation source in the power grid mechanism 16 to drive the target back to the working range, and the first rotor wing mechanism 5 and the second mechanism in the rotor wing device 22 on the unmanned aerial vehicle rack 1 enable the shepherd unmanned aerial vehicle device 26 to operate in high altitude; the supporting leg 24 and the universal wheel 25 support the shepherd unmanned aerial vehicle device 26 operate on the ground and the monitoring information of the shepherd unmanned aerial vehicle device 26 is remotely viewed via the monitor terminal 29 simultaneously, and the shepherd unmanned aerial vehicle device 26 can be remotely controlled via control terminal 30, which can effectively reduce the time and energy consumed in the process of herdsman grazing, accomplish the real-time guardianship and management to the flocks, improving the modernization degree of the animal husbandry.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. An artificial intelligent shepherd bee comprising an unmanned aerial vehicle rack (1), a rotor wing device (2), a power supply device (3), a shepherd device (4) and an unmanned aerial vehicle control host arranged in the unmanned aerial vehicle rack (1);
said rotor wing device (2) comprises first rotor wing mechanisms (5) and second rotor wing mechanisms (6) which are arranged on the unmanned aerial vehicle rack (1); said second rotor wing mechanism (6) is far away from the unmanned aerial vehicle rack (1) compared with the first rotor wing mechanism (5); said first rotor wing mechanism (5) and the second rotor wing mechanism (6) respectively comprise a connecting arm (7), a protective cover (8) and a rotor wing body (9);
said power supply device (3) comprises lithium batteries (10), wind power generation wheel wing mechanisms (11) and a solar panel (12); said lithium battery (10) is arranged at the upper end of the unmanned aerial vehicle rack (1); said wind power generation wheel wing mechanism (11) is arranged in array at the top end of the lithium battery (10) and consists of a fixing plate (13) arranged at the top end of the lithium battery (10) and wheel wings (14) arranged on the fixing plate (13); a liquid crystal control screen (15) is arranged at the upper part of the fixing plate (13) close to the rear end of the unmanned aerial vehicle rack (1); said solar panel (12) is arranged at the top end of the fixing plate (13);
said shepherd device (4) comprises a power grid mechanism (16), an infrared scanning mechanism (17) and a camera (18); said power grid mechanism (16) comprises a power grid body (19) and an electric shock generating source (20); said power grid body (19) is arranged on the outer side of said first rotor wing mechanism (5), and a connecting plate (21) connected with the first rotor wing is arranged on the inner side wall; one end of said electric shock generating source is fixedly connected with the rear end of the unmanned aerial vehicle rack (1) while the other end thereof is fixedly connected with the power grid body (19); said infrared scanning mechanism (17) comprises a fixed frame (22) arranged on the lower side of the first rotor wing mechanism (5) and infrared devices (23) symmetrically arranged on two sides of the bottom end of the fixed frame (22); said camera (18) sets up in unmanned aerial vehicle rack (1) front end.

2. The artificial intelligent shepherd bee of claim 1 wherein said unmanned aerial vehicle rack (1) bottom is equipped with supporting legs (24) which are in array distribution, the universal wheels (25) are provided on the supporting leg (24).

3. The artificial intelligent shepherd bee of claim 1 wherein said first rotor wing mechanisms (5) are four and locate at both sides of unmanned aerial vehicle rack (1) in a mode of bilaterally symmetric to each other.

4. The artificial intelligent shepherd bee of claim 1 wherein said second rotor wing mechanisms (6) are four and locate at both sides of unmanned aerial vehicle rack (1) in a mode of bilaterally symmetric to each other.

5. The artificial intelligent shepherd bee of claim 1 wherein the number of said wind power generation wheel wing mechanisms (11) is not less than 3.

6. The artificial intelligent shepherd bee of claim 1 wherein the number of said infrared scanning modules in the infrared device (23) is not less than 8.

7. The artificial intelligent shepherd bee of claim 1 comprising a shepherd unmanned aerial vehicle device (26), a data analysis module (27), a logic control module (28), a monitoring terminal (29) and a control terminal (30);
said shepherd unmanned aerial vehicle device (26) is used for monitoring and finding targets or target groups within the working range and restraining the targets or the target groups within the working range;
said data analysis module (27) analyzes the monitoring information of the shepherd unmanned aerial vehicle device (26) and sends analysis results to the logic control module (28);
said logic control module (28) judges to control the shepherd unmanned aerial vehicle device (26) according to preset logic control and analysis results;
said monitoring terminal (29) is used for remotely receiving and displaying the monitoring video of the shepherd unmanned aerial vehicle device (26);
said control terminal (30) is used for manually and remotely controlling the shepherd unmanned aerial vehicle device (26).

8. The artificial intelligent shepherd bee of claim 5 wherein the system also comprises a wireless module (31) which is used for receiving or generating data information among the shepherd unmanned aerial vehicle device (26), the monitoring terminal (29) and the control terminal (30).

9. The artificial intelligent shepherd bee of claim 5 wherein said monitoring information is target information acquired by the camera (18) and the infrared scanning mechanism (17).
